(19) United States
(12) Patent Application Publication
(10) Pub. No.: US 2008/0241442 A1
(43) Pub. Date: Oct. 2, 2008

(54) IMAGE INPUT/OUTPUT APPARATUS WITH FREE STOP FUNCTION AND SUPPORT ARM THEREWITH

(76) Inventors: Chern-Shi Lam, Batu Pahat (MY); Yen-Sung Hsieh, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/873,422

(22) Filed: Oct. 17, 2007

(30) Foreign Application Priority Data
Mar. 30, 2007 (TW) 096111468

(51) Int. Cl. B32B 33/00

(52) U.S. Cl. 428/34.1; 428/192

(57) ABSTRACT

A support arm is connected a main body and an open/closed body. An opening is disposed on the main body. The open/closed body is pivoted to the main body in a foldable manner. The support arm includes a connecting part connected to the open/closed body, and a wedge part connected to the connecting part. A notch is formed inside the wedge part, and a first side of the wedge part is a camber. When the wedge part wedges in the opening with different sections on the camber, the wedge part deforms at different deformations so as to hold the open/closed body in different positions relatively to the main body.

### BACKGROUND OF THE INVENTION

1. Field of the Invention

The present invention relates to an image input/output apparatus and a support arm therewith, and more particularly, to an image input/output apparatus with free stop function and a support arm therewith.

2. Description of the Prior Art

Multi-function products (MFPs) integrate various functions of typical functional machines together, such as printing, scanning, facsimile, and copy machines, so that both the cost of purchasing functional machines separately and the required storage space are reduced. MFPs have become mainstream in the market, with placement in schools, classrooms, family households, and studios, and are broadly used as an output device in today's information-oriented society. However an open/closed body of the multi-function product has to be lifted when operating some functions or replacing inner components. For example, a scan module of the multi-function product has to be lifted for a certain height so that a user can replace an ink cartridge inside the multi-function product. A support mechanism connected to the open/closed body and a main body is designed for fixing the open/closed body above the main body to prevent the open/closed body from falling so as to protect hands of the user.

For instance, the multi-function product manufactured by Lexmark® utilizes the mechanism of a support arm for supporting the upper case to fix above the main body. However the conventional mechanism design only provides two stops of fixed positions of the open/closed body relatively to the main body, such as an open status or a close status. It can not provide a free stop function. In addition, the conventional mechanism design utilizes a pod for assisting the support arm to stand on the main body. The user has to lift the open/closed body with one hand and handles the pod to lock or unlock the standing status of the support arm with the other hand when opening or closing the open/closed body. The user cannot only use one hand to open or close the open/closed body. For solving the above-mentioned problem, U.S. Pat. No. 7,069,622 discloses a cam mechanism for the free stop and one-hand opening or closing functions. However the cam mechanism has disadvantages of high cost, complicated mechanical components, and utilizing more mechanical components. There is a need to find a support mechanism of opening or closing the open/closed body of the multi-function product with low cost, few and simple mechanical components, free stop function, and one-hand operation.

### SUMMARY OF THE INVENTION

It is therefore a primary objective of the claimed invention to provide an image input/output apparatus with free stop function and a support arm therewith for solving the above-mentioned problem.

According to the claimed invention, a support arm is connected a main body and an open/closed body. An opening is disposed on the main body. The open/closed body is pivoted to the main body. The support arm includes a connecting part connected to the open/closed body, and a wedge part connected to the connecting part. A notch is formed inside the wedge part, and a first side of the wedge part is a camber. When the wedge part wedges in the opening with different sections on the camber, the wedge part deforms at different deformations so as to hold the open/closed body in different positions relatively to the main body.

According to the claimed invention, an image input/output apparatus includes a main body, an open/closed body, and a support arm. The support arm is connected the main body and the open/closed body. An opening is disposed on the main body. The open/closed body is pivoted to the main body. The support arm includes a connecting part connected to the open/closed body, and a wedge part connected to the connecting part. A notch is formed inside the wedge part, and a first side of the wedge part is a camber. When the wedge part wedges in the opening with different sections on the camber, the wedge part deforms at different deformations so as to hold the open/closed body in different positions relatively to the main body.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an image input/output apparatus of the present invention.

FIG. 2 is a schematic drawing of the image input/output apparatus according to a first embodiment of the present invention.

FIG. 3 is a diagram of an open/closed body fixing in a first position relatively to a main body according to the first embodiment of the present invention.

FIG. 4 is a diagram of the open/closed body fixing in a second position relatively to the main body according to the first embodiment of the present invention.

FIG. 5 is a diagram of the open/closed body fixing in a position relatively to the main body according to the second embodiment of the present invention.

FIG. 6 is a diagram of the open/closed body fixing in a position relatively to the main body according to the third embodiment of the present invention.

FIG. 7 is a diagram of the open/closed body fixing in the first position relatively to the main body according to the fourth embodiment of the present invention.

FIG. 8 is a diagram of the open/closed body fixing in the second position relatively to the main body according to the fourth embodiment of the present invention.

### DETAILED DESCRIPTION

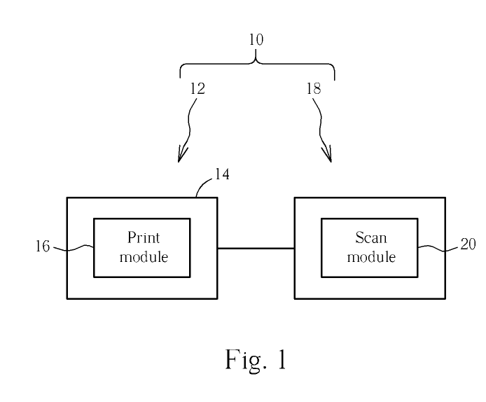

Please refer to FIG. 1. FIG. 1 is a functional block diagram of an image input/output apparatus 10 of the present invention. The image input/output apparatus 10 can be a multi-function product. The image input/output apparatus 10 includes a main body 12 including a housing 14. The image input/output apparatus 10 further includes a print module 16 installed inside the housing 14 of the main body 12 for printing image data as an image output interface of the image input/output apparatus 10. The image input/output apparatus 10 further includes an open/closed body 18 pivoted to the main body 12, and a scan module 20 installed inside the open/closed body 18 for scanning image data as an image input interface of the image input/output apparatus 10. Besides, the print module 16 also can be installed inside the open/closed body 18, and the scan module 20 can be installed inside the main body 12. Functional machines with other functions also can be installed inside the main body 12 and the open/closed body 18, such as a fax module, a copy module, and so on.

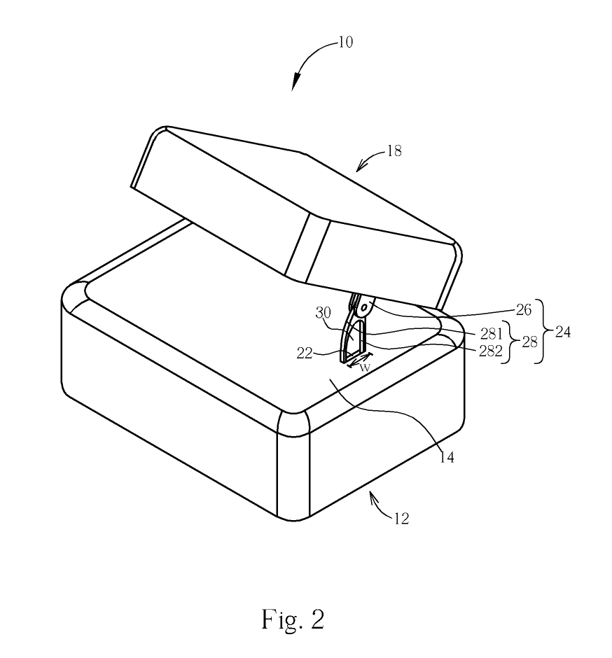

Please refer to FIG. 2. FIG. 2 is a schematic drawing of the image input/output apparatus 10 according to a first embodiment of the present invention. The open/closed body 18 is pivoted to the main body 12 in a foldable manner. An opening 22 is disposed on the housing 14 of the main body 12. The opening 22 can be a slot. The image input/output apparatus 10 further includes a support arm 24 including a connecting part 26 connected to the open/closed body 18 and a wedge part 28 connected to the connecting part 26. A notch 30 is formed inside the wedge part 28. A first side 281 of the wedge part 28 is a camber, and a second side 282 of the wedge part 28 is a plane. The notch 30 is formed between the first side 281 and the second side 282. The connecting part 26 and the wedge part 28 can be integrated in a monolithic structure. The wedge part 28 can be made of elastic material, such as plastic material.

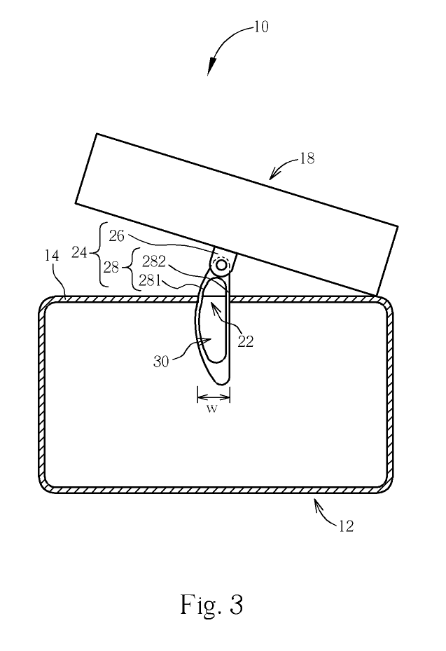

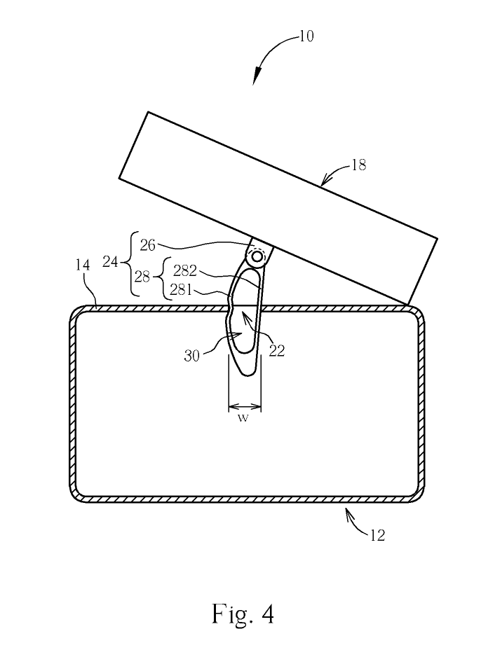

Please refer to FIG. 3 and FIG. 4. FIG. 3 is a diagram of the open/closed body 18 fixing in a first position relatively to the main body 12 according to the first embodiment of the present invention. FIG. 4 is a diagram of the open/closed body 18 fixing in a second position relatively to the main body 12 according to the first embodiment of the present invention. The wedge part 28 wedges in the opening 22 of the housing 14 in a tight fit manner. A width of each cross section of the wedge part 28 is greater than a width W of the opening 22. The wedge part 28 wedges in the opening 22 of the housing 14 in a tight fit manner when the open/closed body 18 is fixed in any position relatively to the main body 12. That is, the wedge part 28 deforms at different deformations by the opening 22 when the first side 281 of the wedge part 28 wedges in the opening 22 with different sections on the camber so as to hold the open/closed body 18 in different positions relatively to the main body 12. The rigidity of the wedge part 28 is reduced so that the wedge part 28 can deform easily because the wedge part 28 is made of elastic material and the notch 30 is formed inside the wedge part 28. When the user lifts the open/closed body 18 from the first position to the second position relatively to the main body 12, a width of the section of the wedge part 28 wedging in the opening 22 increases due to the first side 281 of the wedge part 28 being the camber. The elastic deformation of the wedge part 28 increases accordingly. In addition, the first side 281 of the wedge part 28 is designed as the camber for providing a friction force between the wedge part 28 and the housing 14 via the curvature of the camber so as to slow down the movement of the open/closed body 18. Furthermore, different friction forces between the wedge part 28 and the housing 14 are generated when the open/closed body 18 is fixed in different positions. When the user lifts the open/closed body 18 from the first position to the second position relatively to the main body 12, the deformation of the wedge part 28 and the friction force between the wedge part 28 and the housing 14 increase. That is, it is easy to open the open/closed body 18 in the first position, and it is difficult to open the open/closed body 18 in the second position so that the wedge part 28 wedges in the opening 22 tightly. Then the user can stretch out one's hand inside the main body 12 for replacing components inside the main body 12. In conclusion, the present invention utilizes the wedge connection of the support arm 24 capable of deforming elastically and the opening 22 of the main body 12 as the support mechanism of the open/closed body 18 above the main body 12 so that the open/closed body 18 can be fixed at any angle relatively to the main body 12 for the free stop function. Besides, the user can open or close the open/closed body 18 with one hand.

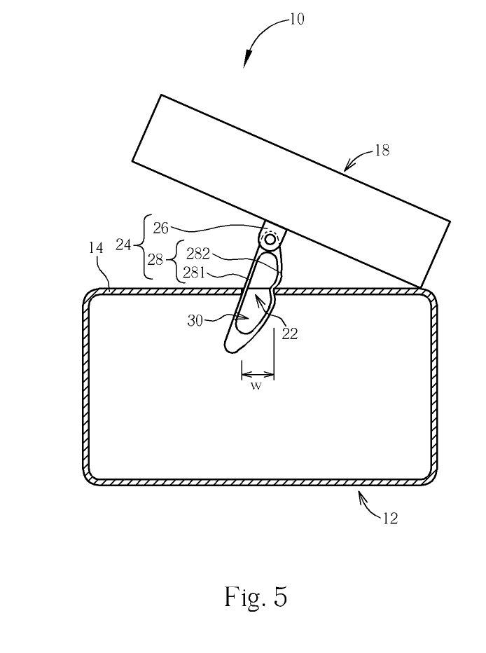

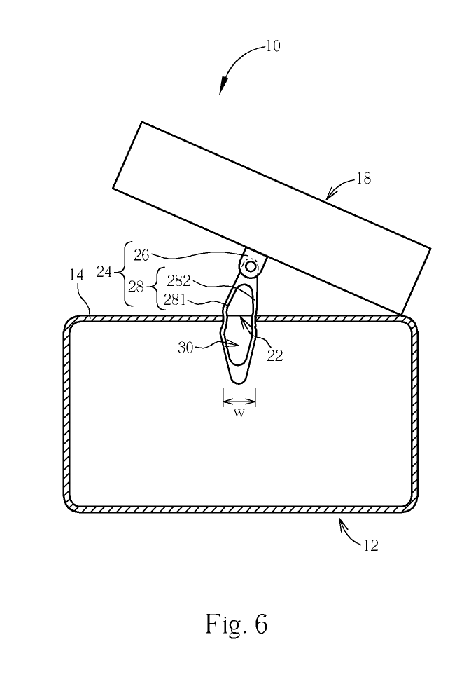

Please refer to FIG. 5 and FIG. 6. FIG. 5 is a diagram of the open/closed body 18 fixing in a position relatively to the main body 12 according to the second embodiment of the present invention. FIG. 6 is a diagram of the open/closed body 18 fixing in a position relatively to the main body 12 according to the third embodiment of the present invention. The difference between the first embodiment and the second embodiment is that the first side 281 of the wedge part 28 is a plane and the second side 282 of the wedge part 28 is a camber according to the second embodiment shown in FIG. 5. The difference between the first embodiment and the third embodiment is that the first side 281 and the second side 282 are both cambers according to the third embodiment shown in FIG. 6. The working principle of the second embodiment and the third embodiment is the same as the one of the first embodiment, and the detailed description is omitted.

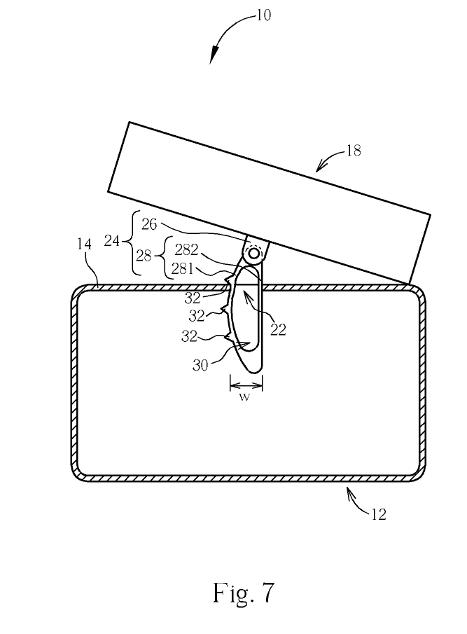

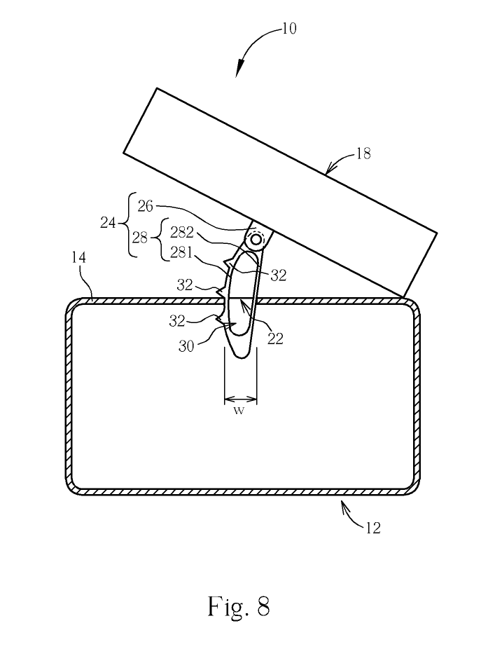

Please refer to FIG. 7 and FIG. 8. FIG. 7 is a diagram of the open/closed body 18 fixing in the first position relatively to the main body 12 according to the fourth embodiment of the present invention. FIG. 8 is a diagram of the open/closed body 18 fixing in the second position relatively to the main body 12 according to the fourth embodiment of the present invention. The difference between the first embodiment and the fourth embodiment is that the support arm 24 further includes a plurality of teeth 32 disposed on the first side 281 of the wedge part 28 for wedging in the opening 22 of the housing 14. Different teeth 32 wedging in the opening 22 of the housing 14 provides multi-angle position of the open/closed body 18. Besides, the plurality of teeth 32 can be disposed on the second side 282 of the wedge part 28.

In contrast to the prior art, the present invention utilizes the wedge connection of the support arm capable of deforming elastically and the opening of the main body as the support mechanism of the open/closed body above the main body. The support mechanism of the image input/output apparatus of the present invention has advantages of low cost, few and simple mechanical components, free stop function, and one-hand operation for opening or closing the open/closed body.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A support arm for connecting a main body and an open/closed body, an opening being disposed on the main body and the open/closed body being pivoted to the main body—, the support comprising:
a connecting part connected to the open/closed body; and
a wedge part connected to the connecting part, a notch being formed inside the wedge part and a first side of the wedge part being a camber, and when the wedge part wedges in the opening with different sections on the camber, the wedge part having different deformations to hold the open/closed body in different positions relatively to the main body.

2. The support arm of claim 1 wherein the wedge part is made of elastic material.

3. The support arm of claim 1 wherein a second side of the wedge part is a plane and the notch is formed between the first side and the second side.

4. The support arm of claim 1 wherein a second side of the wedge part is a camber and the notch is formed between the first side and the second side.

5. The support arm of claim 1 further comprising:
a first tooth disposed on the first side of the wedge part for wedging in the opening of the main body.

6. The support arm of claim 5 further comprising:
a second tooth disposed on the first side of the wedge part and located on a side of the first tooth for wedging in the opening of the main body.

7. The support arm of claim 1 wherein the connecting part and the wedge part are integrated in a monolithic structure.

8. The support arm of claim 1 wherein a width of the wedge part is substantially greater than a width of the opening.

9. An image input/output apparatus comprising:
a main body comprising a housing, an opening being disposed on the housing;
an open/closed body pivoted to the main body; and
a support arm comprising:
a connecting part connected to the open/closed body; and
a wedge part connected to the connecting part, a notch being formed inside the wedge part and a first side of the wedge part being a camber, and when the wedge part wedges in the opening with different sections on the camber, the wedge part having different deformations to hold the open/closed body in different positions relatively to the main body.

10. The image input/output apparatus of claim 9 wherein the opening is a slot.

11. The image input/output apparatus of claim 9 wherein the wedge part is made of elastic material.

12. The image input/output apparatus of claim 9 wherein a second side of the wedge part is a plane and the notch is formed between the first side and the second side.

13. The image input/output apparatus of claim 9 wherein a second side of the wedge part is a camber and the notch is formed between the first side and the second side.

14. The image input/output apparatus of claim 9 wherein the support arm further comprises:
a first tooth disposed on the first side of the wedge part for wedging in the opening of the main body.

15. The image input/output apparatus of claim 14 wherein the support arm further comprises:
a second tooth disposed on the first side of the wedge part and located on a side of the first tooth for wedging in the opening of the main body.

16. The image input/output apparatus of claim 9 wherein the connecting part and the wedge part are integrated in a monolithic structure.

17. The image input/output apparatus of claim 9 wherein a width of the wedge part is substantially greater than a width of the opening.

18. The image input/output apparatus of claim 9 further comprising:
a scan module installed inside the open/closed body; and
a print module installed inside the housing.
